(19) United States
(12) Patent Application Publication
(10) Pub. No.: US 2006/0090179 A1
(43) Pub. Date: Apr. 27, 2006

(54) System and method for embedding supplemental information into a digital stream of a work of content

(76) Inventors: Ya-Ling Hsu, Taipei City (TW); Wen-Hsiang Lee, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/973,675

(22) Filed: Oct. 26, 2004

(51) Int. Cl. H04H 9/00

(52) U.S. Cl. 725/17

(57) ABSTRACT

An apparatus includes a processor and a memory. The memory has a supplemental information module stored therein. The processor is in communication with the memory, and the processor is adapted to receive a given work of multimedia content and implement the supplemental information module to generate a supplemental information record, which includes supplemental information related to the given work of content. The processor is also adapted to generate an enhanced work of content by embedding the supplemental information record into a bit stream comprising the given work of content.

### RELATED APPLICATION

This application is related to co-pending U.S. utility patent application entitled “USING EMBEDDED SUPPLEMENTAL INFORMATION” filed on the same date and accorded Ser. No. ______ (Attorney Docket No. 250318-1130), which is entirely incorporated herein by reference.

### TECHNICAL FIELD

The present invention is generally related to system and methods of recording digital content and, more particularly, is related to a system and method for embedding a supplemental information record, which includes information related to a given work, into a digital stream comprising the given work, and recording the digital stream.

### BACKGROUND

A user of a service provider such as a television system, which include wire, cable, and wireless television systems, receives works of content, e.g., programs, movies, etc. Frequently, the user will record the works of content so that the user can view the works of content at times of his or her own choosing. The user might use a computer system or a digital recorder to record on a storage device the works of content in a digital format. Typically, the storage devices that are employed with computer systems and/or digital recorders of today are large enough to hold many digitized works of content, and the trend for the future is that storage devices will become less expensive with larger storage capacity. Thus, a user of a service provider can create their own library of digitized works of content, and the library can become very large.

Frequently, as a user's library becomes larger and larger, the user will have a harder time managing the library. As the library becomes larger, the user will have a harder time remembering, among other things, which works of content are which; what is the plot of a given work of content; whether a given work of content was good and worth keeping or bad and should be deleted. These are only some of the problems related to managing a large library of works of content. Other problems include, but are not limited to, finding and/or selecting a particular work of content and restricting access to particular works of content.

Thus, there exists a need for an apparatus and a method for providing the user with the ability manage his or her library of digitized works of content.

### SUMMARY OF THE INVENTION

Embodiments of the present invention provide an apparatus and method for generating an enhanced work of content by embedding a supplemental information record for a given work of content into the given work of content. Briefly described, in architecture, one embodiment of the apparatus, among others, includes a processor and a memory. The memory has a supplemental information module or segment stored therein. The processor is in communication with the memory, and the processor is adapted to receive a given work of content and implement the supplemental information module to generate a supplemental information record, which includes supplemental information related to the given work of content. The processor is also adapted to generate an enhanced work of content by embedding the supplemental information record into a bit stream comprising the given work of content.

Embodiments of the present invention can also be viewed as providing methods for creating enhanced works of content. In this regard, one embodiment of such a method, among others, includes the steps of: receiving a given work of content; receiving supplemental information related to the work of content; generating a supplemental information record from the received supplemental information; and generating an enhanced work of content by embedding the supplemental information record in the received work of content.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of one embodiment of a system, which includes a head end of a service provider, for providing works of content to a computer system and to a digital recorder.

FIG. 2 is a block diagram of an analog signal transmitted from the head end of FIG. 1.

FIG. 3 is a block diagram of a digital transport stream carrying a multiple works of content.

FIG. 4 is a block diagram of the computer system of FIG. 1.

FIG. 5 is a block diagram of memory.

FIG. 6 is a block diagram of a storage device.

FIG. 7 is a flow chart that depicts a method of embedding a supplemental information record into a work of content.

FIG. 8A is a flow chart that depicts a method of extracting supplemental information from a digital transport stream.

FIG. 8B is a flow chart that depicts a method of extracting supplemental information from an analog signal.

FIG. 9 is a flow chart that depicts a method of generating a supplemental information record.

FIGS. 10A and 10B depict two methods of packetizing a supplemental information record.

### DETAILED DESCRIPTION OF THE PREFERRED EMBODIMENT

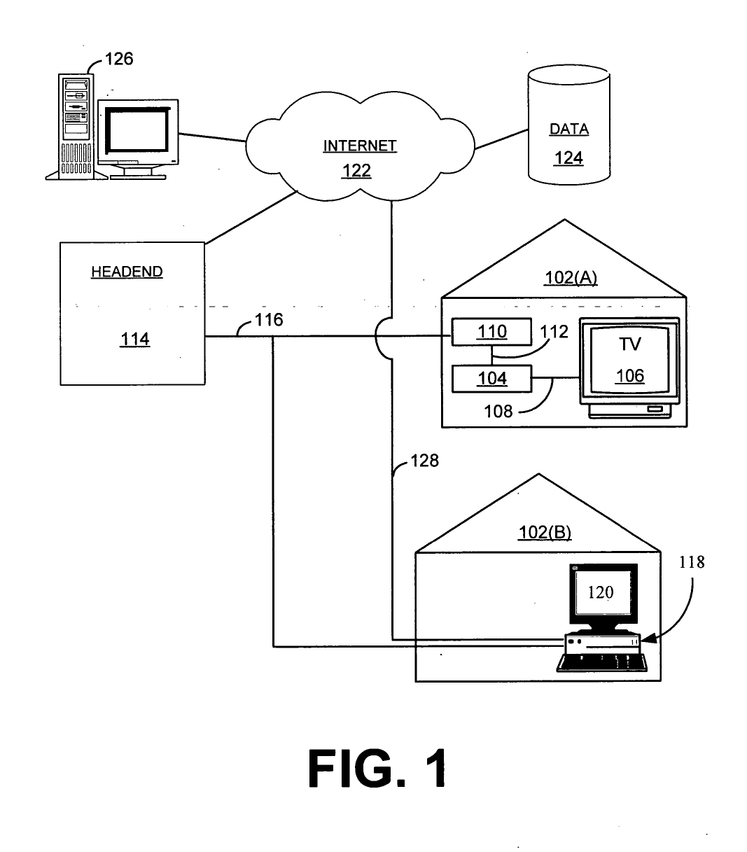

Referring to FIG. 1, located in a first user premise 102(A) is a digital recorder 104. The digital recorder 104 is in communication with a display device 106, which is typically a television set, via a communication link 108. The digital recorder 104 is adapted to receive works of content, determine supplemental information related to the received works, and generate a supplemental information record having the supplemental information included therein. The digital recorder 104 is also adapted to record enhanced works of digital content. For the purposes of this disclosure an “enhanced work” is defined as a compilation of a work of content and a supplemental information record, wherein the supplemental information record includes information related to the work. Typically, the supplemental information record is embedded into the work of content during the recording of the work of content. Furthermore, the digital recorder 104 is adapted to manage the recorded enhanced works using the supplemental information record embedded within the enhanced work.

In one embodiment, the digital recorder 104 is also in communication with a settop box 110 via communication link 112. The settop box 110 receives works of content from a head end 114 of a service provider via a communication link 116. Typically, the works of content from the service provider include encrypted works, and the settop box 110 is adapted to decrypt the encrypted works before providing them to the digital recorder 104. In some embodiments, the digital recorder 104 is adapted to receive encrypted works of content and decrypt them so that the settop box 110 is unnecessary.

A computer system 118, which is located in the subscriber premises 102(B) is also in communication with the head end 114 of the service provider via the communication link 116 and with the internet 122 via communication link 128. The computer system 118 includes a display device 120 on which content can be displayed to a user. The computer system 118 is adapted to receive works of content, determine supplemental information related to the received works, and generate a supplemental information record having the supplemental information included therein. The computer system 118 is also adapted to record enhanced works of digital content. Similar to the digital recorder 104, the computer system 118 is also adapted to manage the recorded enhanced works using the supplemental information record embedded within the enhanced work.

In some embodiments, the service provider is a cable television or a subscription television service provider, and the communication link 116 is a wired, optical, or wireless communication link. Typically, the head end 114 provides works of content in both analog and digital format, and frequently, the service provider also provides Internet services to its users. In that case, the digital recorder 104 is in communication with a database 124 and with a server 126 via the Internet 122.

The database 124 includes supplemental information related to given works of content. Non-limiting examples of supplemental information for a given work of content include: title; episode name/title; year of copyright; content rating, e.g., General (G), Parental Guidance (PG), PG-13, Restricted (R), NC-17; performers (actors, actresses, musicians, etc.); genre (adventure, romance, action, animation, documentary, western, science fiction, etc.); awards (Oscar, Tony, People's Choice, Golden Palm, etc.) and category of award (best actor, best actress, best motion picture, best special effects, etc.); and critical reviews, e.g., published reviews by movie critics. In some embodiments, the database 124 is adapted to respond to query messages from the digital recorder 104 and/or the computer system 118 by providing supplemental information requested by the query message. In another embodiment, the database 124 is searchable such that the digital recorder 104 and/or the computer system 118 can search for and retrieve supplemental information. Furthermore, in some embodiments, the database 124 also includes works of content that can be provided to the digital recorder 104 and the computer system 118.

In some embodiments, the server 126 can provide works of content and/or supplemental information related to a given work of content to the digital recorder 104 and/or the computer system 118. The server 126 is adapted to receive a query message from the digital recorder 104 and/or the computer system 118 and search the database 124 for supplemental information related to a given work of content. The server 126 is also adapted to provide the sender of the query message with a response, which includes the search results, e.g., supplemental information record, from the database 124. The server 126 can also provide works of content, which are stored in the database 124, to the digital recorder 104 and the computer system 118.

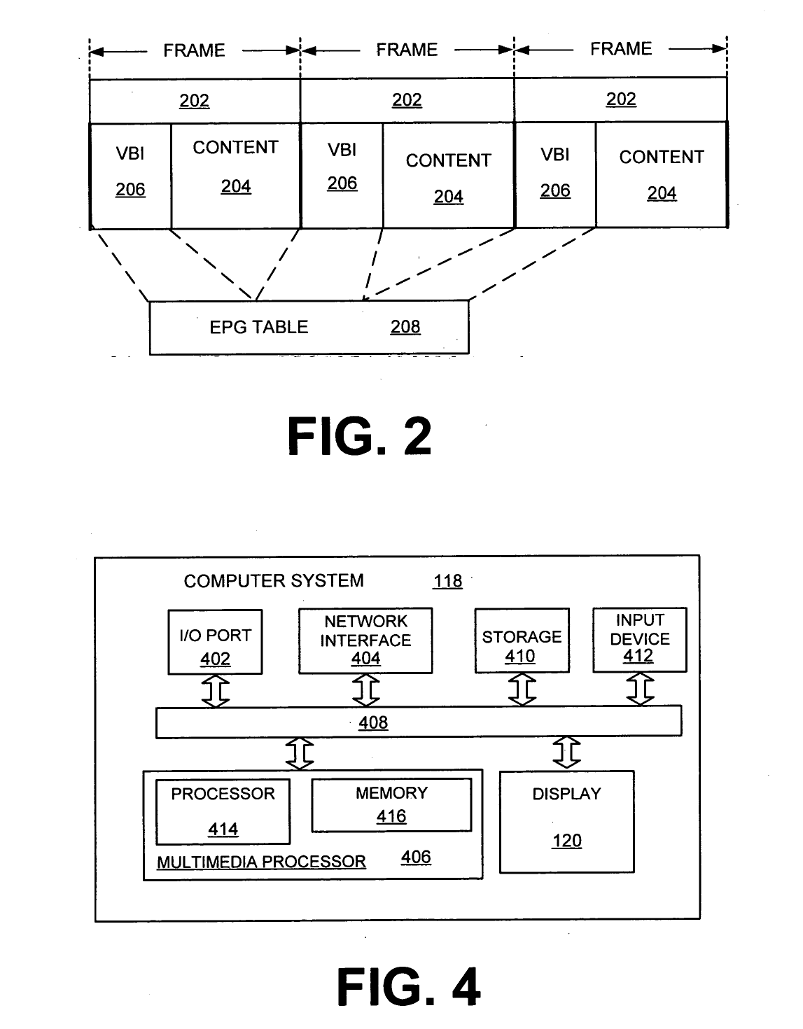

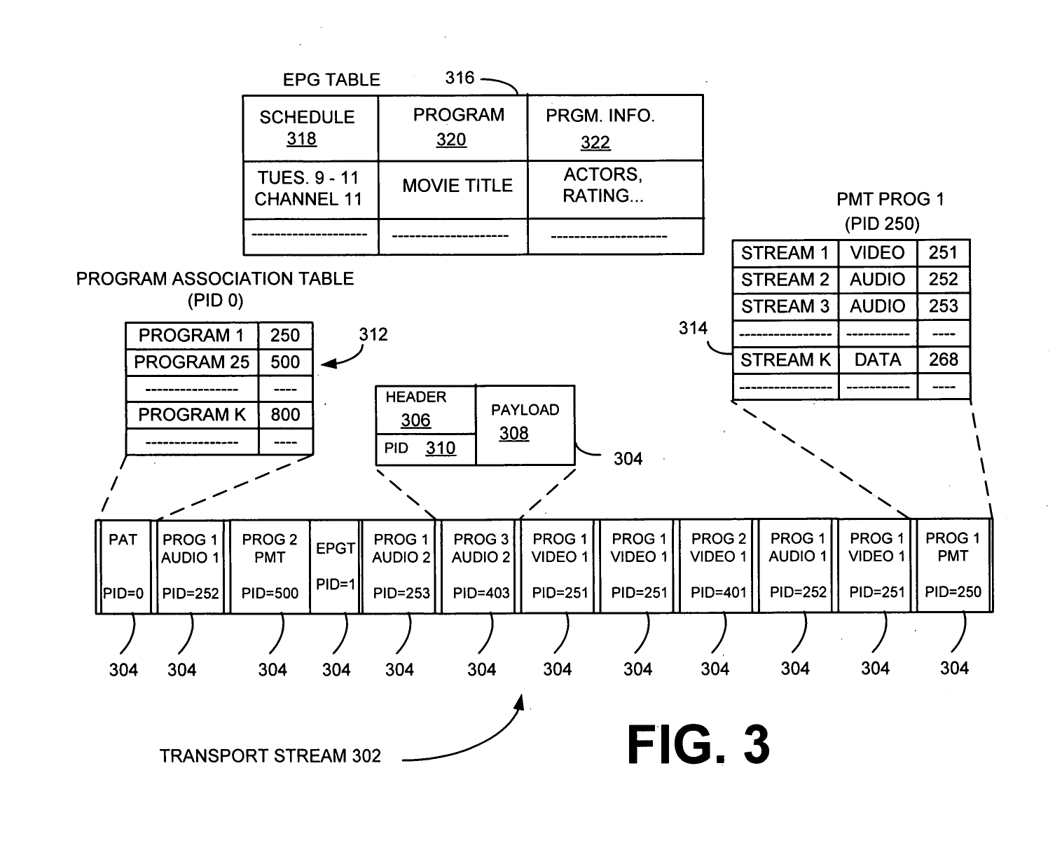

FIGS. 2 and 3 illustrates the transmission of a portion of a work of content in analog format and digital format, respectively. In FIG. 2 several frames 202 are shown. Each frame 202 includes content information 204 and a vertical blanking interval (VBI) 206. The content information 204 includes the information for generating a picture on a television screen. The VBI 206 includes a series of pulse signals that are used to reset the electron gun in a television set to its start position so that the electron gun can paint the screen of the TV with a new picture. In the United States, the refresh rate for a television is 60 hertz. The vertical blanking interval is also used to carry other information such as, but not limited to, an electronic program guide table (EPGT) 208. Typically, the EPGT 208 includes information related to the scheduling of future works of content, i.e., works of content that are to be transmitted in the upcoming days or weeks.

FIG. 3 illustrates a digital transport stream 302. The digital transport stream 302 is made up of a stream of transport packets 304, each of which usually carries a portion of a work of content or system information. Typically, the digital stream 302 is made up of a multiplex of transport packets 304 from several works of content, and in some embodiments, the digital transport stream 302 includes transport packets 304 that carry a portion of an EPGT. In other embodiments, an EPGT can be transmitted out of band from the head end 104 to the user premises 102, i.e., the EPGT is transmitted in a communication path that is not a multiplex transport streams carrying works of content.

In one embodiment, the transport packets 302 are MPEG transport packets, which are 188 bytes in size. An MPEG transport packet includes a header portion 306, which is 4 bytes in size and a payload portion 308, which is 184 bytes in size. The header portion 306 includes, among other things, a program identifier (PID) 310, which is 13 bits in size. The payload portion 308 is used to carry content such as video content, audio content, and other information such as tables and service data including EPGTs.

The PID 310 of a transport packet, which is generally set by the service provider, uniquely identifies the transport packet 304 as being a packet included in a specific stream of packets. For example, transport packets 304 for which the value of the PID 310 is “0” typically carry a portion of a program association table (PAT) 312 in their payloads. The transport stream 302 also carries tables such as program map tables (PMT) 314 and EPGTs 316.

The PAT 312 associates programs or works of content, carried in the transport stream 302 with PMTs 314 using PIDs 310. For example, “program 1” is associated with a PMT 314 that is carried in the transport packets 304 having the PID value of 250. The PMT 314 associates elementary bit streams of a work of content, e.g., a program, with specific values of PIDs 310.

Elementary bit streams of a work of content generally include a video bit stream, an audio bit stream, and other program data. Program data might include things such as “director's cut” of the program. Frequently there might be several audio bit streams for a work of content so that the work can be heard in different languages. For example, the elementary bit stream that comprises the video of “program 1” is carried by transport packets 304 that are identified by the PIDs having the value of 251. The English audio elementary stream is carried by the transport packets 304 that are identified by the PIDs having the value 252, and so on.

The EPGT 316 is received by an EPG module, generally located in the settop box 110 and/or the digital recorder 104 as shown in FIG. 1, but in some embodiments, the computer system 118 also includes an EPG module. The EPG module receives the EPGT 316 and reads the content of the EPGT to provide information to a user so that the user can, among other things, determine the schedule (time and channel) of a program and program information for the programs.

Frequently, EPGTs include information about future programming. For example, an EPGT that is received today might have programming information for programs that are one week from now. Thus, the EPGT that is carried in the transport stream, or VBI, of today might not include programming information about the current programs of today. An EPG module or application will use old and new EPGTs to provide programming and scheduling information and the EPG module or application will delete/replace EPGTs as they expire.

The EPGT 316 associates schedule information 318 with a program 320 and program information 322. The schedule information 318 includes scheduling information such as date, time, and channel and the program information 322 may include information such as, but not limited to, program title, episode name, director, performers, content rating, year of production, year of copyright, awards including category of awards, and other supplemental information.

FIG. 4 illustrates selected components of the computer system 118. Generally, the digital recorder 104 includes the components, except for the display 120, illustrated in FIG. 4. Thus, the digital recorder 104 is not discussed in detail. The computer system 118 includes an input/output port 402, which is adapted to couple with communication link 116, and a network interface 404, which is adapted to couple to the communication link 124. Works of multimedia content can be received through the I/O port 402 and through the network interface 404. The received works of multimedia content are provided to a multimedia processor 406 via a bus 408. The I/O port 402 may include a plurality of interfaces such that it can receive (and provide) content from (and to) a plurality of devices in a plurality of formats.

A network interface comprises various components used to transmit and/or receive data over networks. By way of example, the network interface device 404 may include a device that can communicate with both inputs and outputs, for instance, a modulator/demodulator (e.g., a modem), wireless (e.g., radio frequency (RF)) transceiver, a telephonic interface, a bridge, a router, network card, etc.).

A mass storage device 410 is in communication with the multimedia processor 406 via the bus 408. The mass storage device 410 is adapted to store enhanced works of content so that the works included therein can be replayed. A user can use an input device 412 for providing user input. For the computer system 118, the input device 412 is generally a keyboard and mouse. However, for the digital recorder 104 the input device 412 can be, but is not limited to, a keypad, a remote control, or other devices known to those skilled in the art such as a stylus.

The multimedia processor 406 includes a processor 414 and a memory 416. Among other things, the processor 414 implements user commands and modules stored in the memory 416. The memory 416 can include any one of a combination of volatile memory elements (e.g., random-access memory (RAM, such as DRAM, and SRAM, etc.)) and nonvolatile memory elements (e.g., ROM, hard drive, tape, CDROM, etc.).

The multimedia processor 406 is adapted to receive content and then reformat, if necessary, the content to a desired format such as, but not limited to, motion pictures expert group (MPEG), Advanced Visual Interface (AVI), Windows Media Video (WMV), Digital Versatile Disc (DVD), Versatile Compact Disc (VCD), and others known to those skilled in the art. Among other reasons, the multimedia processor 406 reformats works of multimedia content so that the works are in appropriate format for display and so that the works are physically compressed on the mass storage device 410.

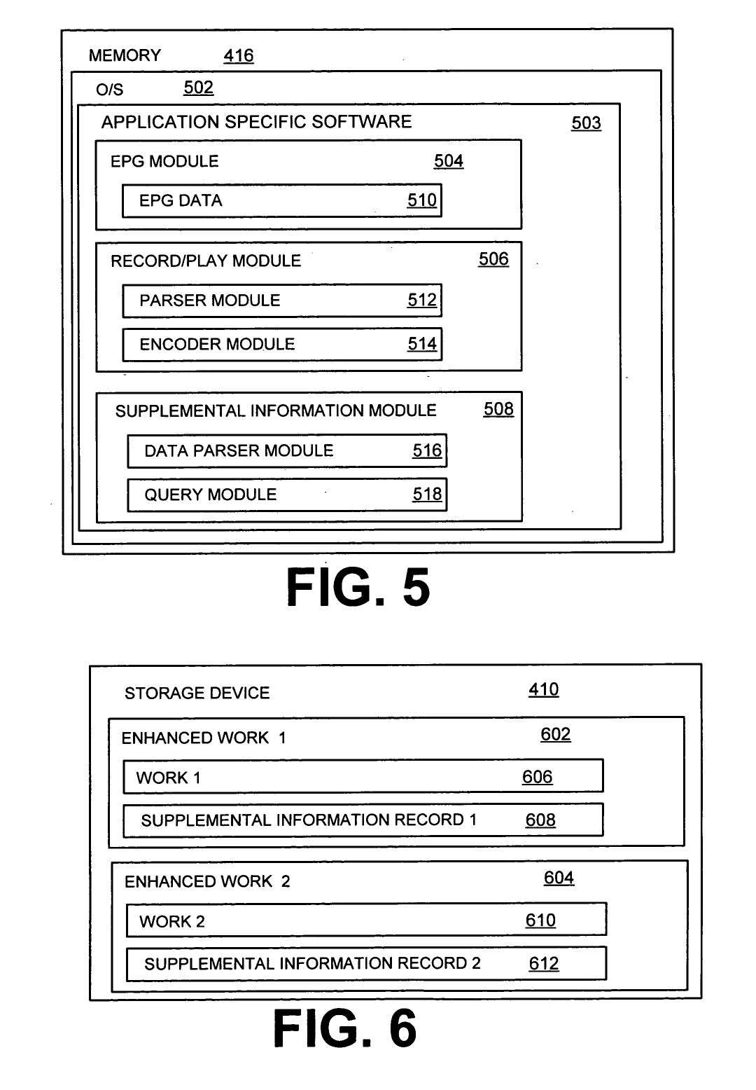

FIG. 5 further illustrates the memory 416. The memory 416 includes an operating system 502 and an application specific module 503, which includes an EPG module 504, a record/play module 506, and a supplemental information module 508. The processor 414 implements the O/S 502 to, among other things, provide menu options to the user and interpret user input. In some embodiments, the memory 416 may include one or more native applications, emulation systems, or emulated applications for any of a variety of operating systems and/or emulated hardware platforms, emulated operating systems, etc. One of ordinary skill in the art will appreciate that memory 416 can, and typically will, comprise other components, which have been omitted for purposes of brevity.

The application specific software program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

The EPG module 504 includes logic for providing electronic program guide functionality, such as but not limited to, displaying programming information and providing recording instructions to the record/play module 506. The EPG module 504 includes the EPG data 510, which is provided to the EPG module 504 via EPGTs 208 and 316. Typically, the EPG data 510 includes information related to the currently received programming and upcoming programming, e.g., programming information up to one week in advance. In some embodiments, some or all of the information included in the EPG data 510 is provided by the database 124 and/or the server 126.

Typically, a user will employ the EPG module 504 when the user wants to program the digital recorder 104 (and/or the computer system 118) to record an upcoming work or to see what is currently playing. The EPG module 504 provides the user with various menus such that the user can select to record based upon a selected day, time and channel, or based upon a selected work of content (program). If the user selects based upon a work of content (program), the EPG module 504 consults the EPG data 510 to determine the scheduling information (date, time, channel) of the work of content (program). The EPG module 504 provides the scheduling information to the record/play module 506.

Sometimes, the selected work of content (program) is received at the digital recorder 104 and/or computer 118 in a digital transport stream. In that case, the EPG module 504 may provide the record/play module 506 with the appropriate packet identifiers for the packets that comprise the streams of the selected work of content (program). In the case of an MPEG transport stream, the EPG module 504 will use PATs and PMTs to determine the PIDs that comprise the selected work of content (program).

Among other things, the record/play module 506 includes logic for recording works of content and playing back recorded works of content. The record/play module 506 receives scheduling information and/or the values of PIDs from the EPG module 504 for recording selected works of content (programs) and provides a user with menus for playing back recorded “enhanced works.” The record/play module 506 includes a parser 512 and an encoder 514. The parser 512 is adapted to receive transport streams and parse selected packets from the transport stream. Generally, the parser 512 is programmable to parse selected packets at selected times. The parser 512 uses PIDs or other identifiers to parse selected packets from the transport stream.

The encoder 514 is adapted to receive content including supplemental information records from the supplemental information module 508 and encoder and packetize the content into a desired format such as, but not limited to, motion pictures expert group (MPEG) including MPEG-1 and MPEG-2, Advanced Visual Interface (AVI), Windows Media Video (WMV), Digital Versatile Disc (DVD), Versatile Compact Disc (VCD), and others known to those skilled in the art. In some embodiments, the encoder 514 receives an analog signal and encodes the signal into a digital format. In other embodiments, the encoder 514 receives content in a digital format and encodes it into a second digital format. Typically, received digital content is not encoded by the encoder 514, rather it is passed through to the storage device 410.

In some embodiments, the encoder 514 receives digital content from the parser 512 and a supplemental information record from the supplemental information module 508. The encoder 514 encodes the supplemental information record such that the encoded supplemental information record is in the same format as the received digital content. In some embodiments, the encoder 514 will modify tables such as PMTs belonging to the received digital content so that the supplemental information record is indexed within the PMT. In other embodiments, the encoder 514 will denote or flag the supplemental information record using special or reserved identifiers.

The supplemental information module 508 includes logic for generating a supplemental information record. The supplemental information module 508 is adapted to receive information from the EPG module 504 and other sources including, in some embodiments, user input. The supplemental information module 508 includes a data parser module 516 and a query module 518. The data parser module 516 is adapted to parse the EPG data 510 for selected information. Thus, when the user selects a work of content (program), the data parser 516 extracts program information for that selected work of content (program) from the EPG data 510. Examples of program information include, but are not limited to, program title, episode name/title, year of copyright, content rating, performers (actors, actresses, musicians, etc.), genre (adventure, romance, action, animation, documentary, western, science fiction, etc.), awards and category of award(s), and critical reviews.

Sometimes, the program information extracted from the EPG data 510 is incomplete and/or not up to date. For example, the program information might not include awards that were recently won by the work of content (program). The query module 518 is adapted to query providers of information such as database 124 and/or server 126 for program information related to the selected work of content (program). The query module 518 normally provides the database 124 and/or server 126 with the program name, copyright year, etc., such that the database 124 and/or server 126 can provide the digital recorder 104 (or computer 118) with correct information. When the supplemental information module 508 receives program information from the EPG data 510 or from the database 126 or from the server 126, the supplemental information module 508 formats the information according to a predetermined format or table. The formatted program information is then provided to the encoder 514 as a supplemental information record. In some embodiments, the supplemental information module 508 provides a supplemental information record, which includes the information parsed from the EPG data 510, and a further supplemental information record, which includes information received from the database 124 or server 126.

FIG. 6 illustrates the storage device 410 with enhanced works 602 and 604 stored therein. The enhanced work 602 includes “WORK 1” 606 and a supplemental information record 608. Similarly, the enhanced work 604 includes “WORK 2” 610 and a supplemental information record 612. The storage device 410 can be a hard drive, optical drive, tape drive or other device for storage electronic information. The supplemental information records 608 and 612 are embedded into the enhanced works 602 and 604, respectively. Because the supplemental information record 608 is part of the enhanced work 602, if the enhanced work 602 is copied, or deleted, the supplemental information record 608 is copied, or deleted with “WORK 1” 606.

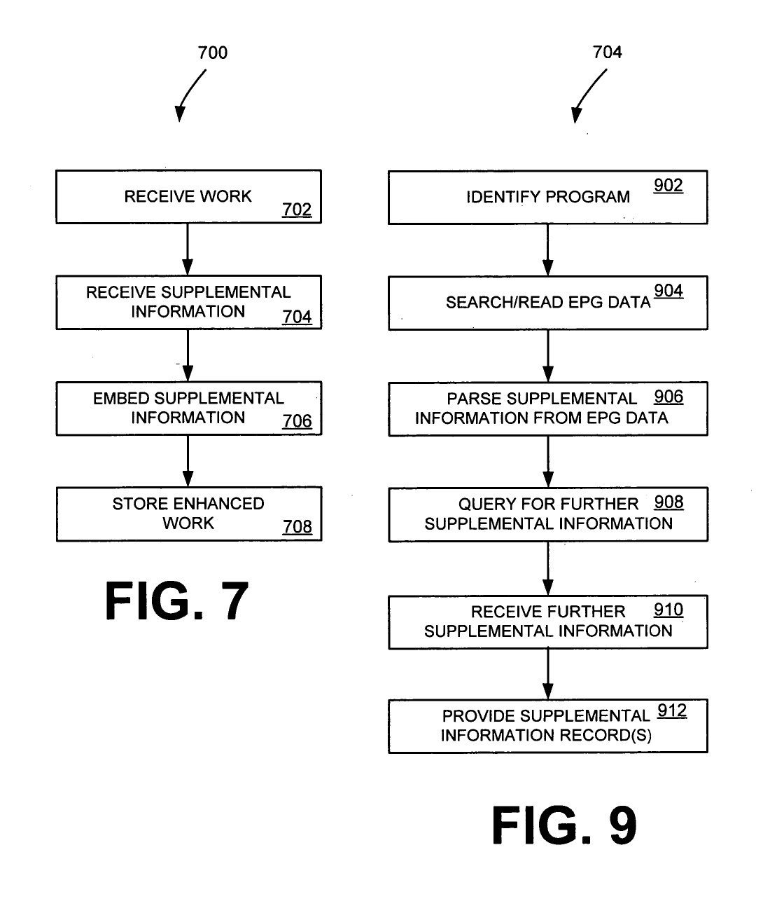

FIG. 7-10 are flow charts of steps that may be taken by the digital recorder 104 and/or the computer system 118. The flow charts illustrated in FIGS. 7-10 show the architecture, functionality, and operation of a possible implementation of the application specific software 503. In this regard, each block represents a module, segment, or portion of code, which comprises one or more executable instructions for implementing the specified logical function(s). It should also be noted that in some alternative implementations, the functions noted in the blocks may occur out of the order noted in FIGS. 7-10. For example, two blocks shown in succession in any of the FIGS. 7-10 may in fact be executed substantially concurrently or the blocks may sometimes be executed in the reverse order, depending upon the functionality involved, as will be further clarified hereinbelow.

Steps 700, which are illustrated in FIG. 7, are illustrative of a general method for creating an enhanced work. In step 702, a work of content is received, and in step 704, supplemental information that is related to the given work is received. Next, in step 706, a supplemental information record is embedded in the received work of content, thereby creating an “enhanced work.” Then in step 708, the enhanced work is stored.

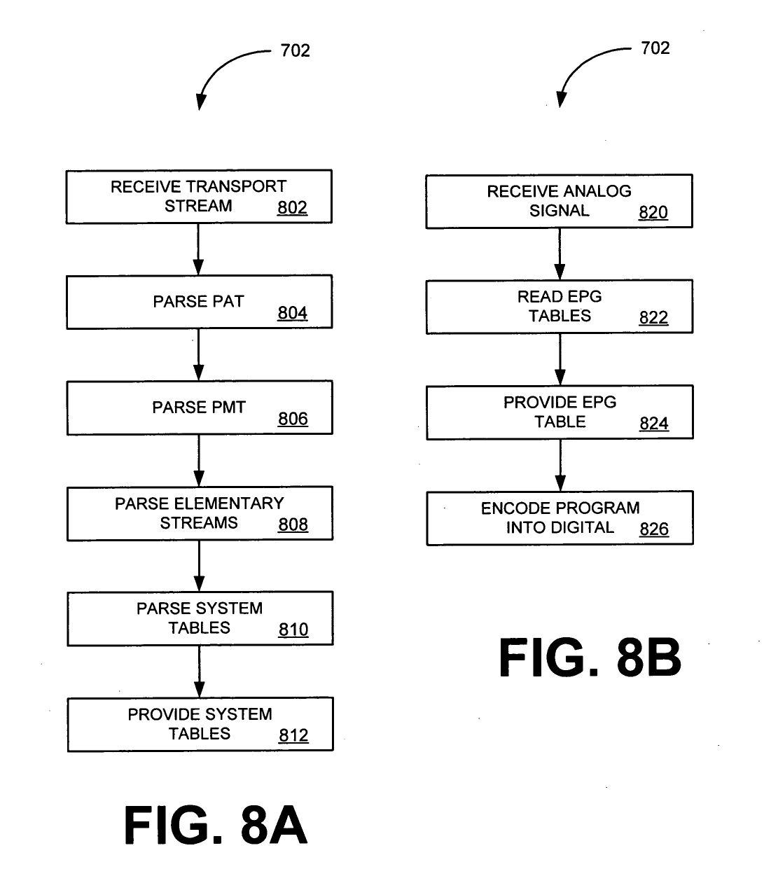

FIGS. 8A and 8B further illustrates the steps that may be taken during the step of receiving the work of content. FIG. 8A illustrates exemplary steps taken when the work is received in a digital transport stream, and FIG. 8B illustrates exemplary steps when the received work is carried by an analog signal. For the digital case, in step 802, a transport stream is received. The transport stream is generally a multiplex of programs (or works of content) which are carried in packets. The transport stream generally employs a PAT/PMT/PID type architecture, i.e., where PIDs 310 identify packets within the transport stream 302; PMTs 314 identify the PIDs of packets that are carrying a work of content (program); and the PAT 312 identifies the PMTs of the works of content (programs) carried within the transport stream 302.

In step 804, a first table such as a program association table is parsed from the transport stream. The first table associates works of content (programs) that are carried in the transport stream with second tables such as program map tables (PMTs). In step 806, one of the second tables is parsed from the transport stream. The second table corresponds to a particular work of content (program) carried by the transport stream. The particular work of content (program) is the one that the user has chosen to record/save and/or view. The second table associates unique identifiers or packet identifiers with the packets that carry the elementary streams that make up the selected work of content (program).

In step 808, the elementary streams that comprise the selected work of content (program) are parsed from the transport stream. Also, in step 810, system tables including EPGTs 316 are parsed from the transport stream, and then, in step 812, the system tables are provided to various applications and/or modules. For example, the EPGT 316 is provided to the EPG module 504.

Referring now to FIG. 8B, in step 820, a work of content, which is carried by an analog signal is received. The analog signal includes VBIs, and the VBI carries information such as EPGTs 208. In step 822, EPGTs 208 carried in the VBI are read. In step 824, the content of the EPGTs 208 are provided to the EPG module 504 and stored in the EPG data 510.

Next, in step 826, the analog work of content (program) is encoded into a digital format by the encoder module 514. Generally, the analog work of content (program) is encoded into a plurality of digital streams such as a video elementary stream and an audio elementary stream, etc.

FIG. 9 illustrates exemplary steps, which may be taken during step 704. In step 902, the digital recorder 104 (or the computer system 118) identifies the work of content (program) selected by the user so that the supplemental information module 508 can generate a supplemental information record for the work of content. If the user selected a work of content (program) using the EPG module 504, then the supplemental information module 508 receives the title of the work of content (program), or, in some embodiments, the supplemental information module 508 receives the scheduling information of the selected work of content (program). If the user programmed the digital recorder 104 (or the computer system 118) to record a specific channel at a specific time and date, then the supplemental information module 508 receives the scheduling information (date, time, channel). The supplemental information module 508 uses the scheduling information to identify a particular work of content (program) using the EPG data 510. In some embodiments, the supplemental information module 508 can determine the particular work of content (program) by querying the database 124.

Next, in step 904, the EPG data 510 stored in memory 414 is searched/read. Then, in step 906 supplemental information for the particular work of content (program) identified in step 902 is parsed from the EPG data 510. The supplemental information module 508 formats the supplemental information into a predetermined format, thereby creating a supplemental information record.

In some embodiments, the EPG data 510 might not contain complete supplemental information. In that case, the digital recorder 104 (and/or computer system 118) is adapted to use the program information that it has parsed from the EPG data 510 to search for further supplemental information. For example, the supplemental information in the EPG data 510 might indicate the title, year, and starring actors of the particular work of content (program). However, the EPG data 510 might not include information such as awards won or critical reviews. In step 908, the digital recorder 104 (and/or computer system 118) can use the title, and if necessary year of production or year of copyright to query the database 124 and/or server 126 for further supplemental information. Then, in step 910, responsive to the query, the digital recorder 104 (and/or computer system 118) receives the further supplemental information. Generally, the further supplemental information is included in the supplemental information created in step 906, but, in some embodiments, the supplemental information module 508 creates another supplemental information record using the further supplemental information.

As previously stated hereinabove, in some embodiments, a user supplies user input to the supplemental information module 508. The user input can include information such as facts that the user knows about the work and other information. A non-limiting example of other information is a user supplied review and/or content rating of the work. Thus, a user can create his or her own content rating system that is different from industry defined systems. Also, if the supplemental information record for the work is incomplete, the user can supply some or all of the missing information.

Next, in step 912, the supplemental information module 508 provides the supplemental information record(s) to the encoder module 514.

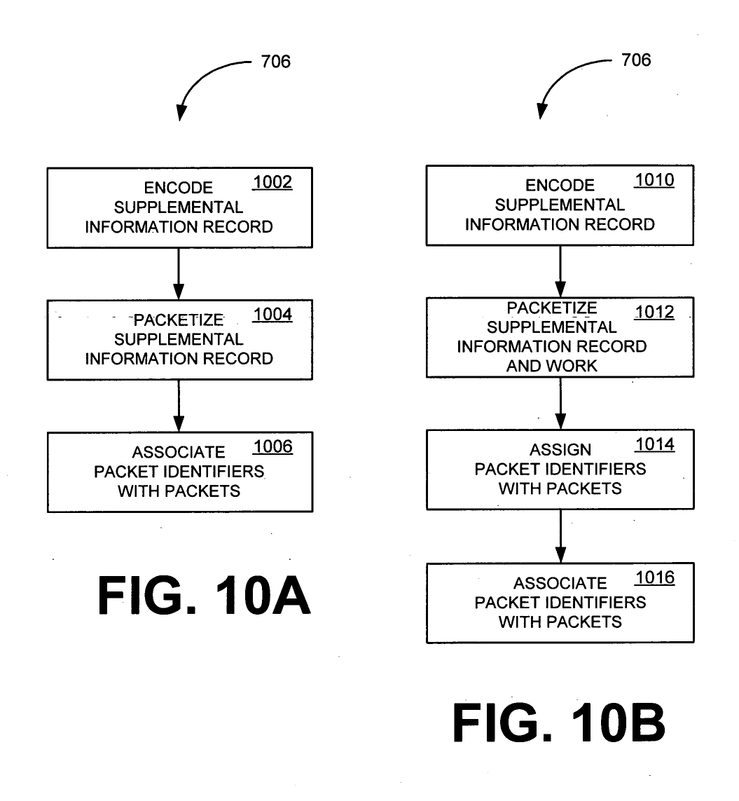

FIGS. 10A and 10B illustrate exemplary steps for embedding a supplemental information record into a work when the work is received as digital content and analog content, respectively. Referring to 10A, in step 1002 a supplemental information record is encoded. The supplemental information record is encoded using the same protocols for which the work of digital content will ultimately be recorded. In some embodiments, a work of digital content is received in a first format that is in accordance with a first protocol then the work is encoded into a second format that is in accordance with a second protocol. Thus, if the work is stored in the second format, then the supplemental information record is encoded using the second format. In some embodiments, the supplemental information record is encoded into a format, such as, but not limited to, MPEG-1 and MPEG-2, Advanced Visual Interface (AVI), Windows Media Video (WMV), Digital Versatile Disc (DVD), Versatile Compact Disc (VCD), and others known to those skilled in the art.

In step 1004, the encoded supplemental information record is packetized. For example, in one embodiment, the supplemental information record is packetized into MPEG packets.

In step 1006, a unique identifier such as a PID is associated with packets carrying the supplemental information record. In one embodiment, a reserved PID is associated with the packetized supplemental information record. Elementary streams of works of content (programs) do not use reserved PIDs. For example, in an MPEG transport stream from the server provider 104 some PIDs are reserved such as the PID values of zero and 8,191, which are frequently reserved for system packets and stuffing packets, respectively. Consequently, the reserved PID values are available to the digital recorder 104 (or computer 118) for assignment to the packetized supplemental information record because the PIDs of the elementary streams of the work of content (program) will not have these reserved values. In some embodiments, a PID value that is not used to identify elementary streams of the work of content (program) being recorded will be assigned. For example, if the elementary streams of the work of content (program) use PID values such as 256, 258, and 261, then other PID values such as 257 can be used to identify packets of the supplemental information record. In that case, the digital recorder will edit the PMT of the work of content (program) to index the supplemental information record and its associated PID value.

An advantage of using reserved PIDs for identifying packets carrying a supplemental information record is that the supplemental information records of all of the enhanced works stored on the storage device 410 can be similarly identified. In that case, the digital recorder 104 does not need to use the PMTs or similar tables of recorded enhanced works to determine the PID values that identify supplemental information records in the different recorded enhanced works.

Referring to FIG. 10B, in step 1010, the supplemental information record generated by the supplemental information module 508 and the work of content are encoded. The work of content is encoded into its elementary streams. Next, in step 1012, the encoded supplemental information record and the encoded work of content are packetized, and in step 1014, packet identifiers are assigned to the packets. Thus, the packets that carry the supplemental information record will be assigned a first packet identifier; the packets that carry the video portion of the work of content will be assigned a second packet identifier, and so on. In step 1016, the packet identifiers are associated with the packets. For an MPEG transport packet 304, the PID 310 is set to the value assigned.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of processing a work of content, the method comprising the steps of:
receiving a given work of content;
receiving supplemental information related to the given work of content;
generating a supplemental information record from the received supplemental information; and
generating an enhanced work of content by embedding the supplemental information record into a bit stream having the received work of content.

2. The method of claim 1, further including the step of:
formatting the supplemental information record in accordance with a particular protocol, wherein the enhanced work of content is formatted in accordance with the particular protocol.

3. The method of claim 1, further including the steps of:
parsing the work of content from a stream of transport packets; and
parsing selected transport packets from the stream of transport packets, wherein the selected transport packets carry at least a portion of the supplemental information.

4. The method of claim 1, wherein the received supplemental information is included in data for an electronic program guide, and further including the steps of:
retrieving the data for the electronic program guide; and
parsing the supplemental information from the data.

5. The method of claim 1, further including the step of:
querying a database for the supplemental information.

6. The method of claim 1, further including the step of:
converting the work of content from a first format to a second format, wherein the work of content is received in the first format.

7. The method of claim 6, wherein the first format is an analog format, and the second format is a digital format.

8. The method of claim 7, wherein the analog format includes a vertical blanking interval carrying supplemental information, and further including the step of:
parsing the supplemental information during the vertical blanking interval.

9. The method of claim 7, wherein the analog format includes a vertical blanking interval carrying information for an electronic program guide, and further including the steps of:
parsing the information for the electronic program guide during the vertical blanking interval; and
parsing the supplemental information from the electronic program guide.

10. The method of claim 1, wherein the enhanced work of content is stored in an MPEG format, and the supplemental information record is stored in a transport packet having a reserved packet identifier.

11. The method of claim 1, wherein the enhanced work of content includes a program map table, the program map table associating a packet identifier with the supplemental information record.

12. A program embodied in a computer readable medium, the program comprising:
logic configured to receive a given work of content;
logic configured to receive supplemental information related to the given work of content;
logic configured to generate a supplemental information record from the received supplemental information; and
logic configured to generate an enhanced work of content by embedding the supplemental information record into a bit stream having the received work of content.

13. The program of claim 12, further including:
logic configured to format the supplemental information record in accordance with a particular protocol, wherein the enhanced work of content is formatted in accordance with the particular protocol.

14. The program of claim 12, further including:
logic configured to parse the work of content from a stream of transport packets; and
logic configured to parse selected transport packets from the stream of transport packets, wherein the selected transport packets carry at least a portion of the supplemental information.

15. The program of claim 12, wherein the received supplemental information is included in data for an electronic program guide, and further including:
logic configured to retrieve the data for the electronic program guide; and
logic configured to parse the supplemental information from the data.

16. The program of claim 12, further including:
logic configured to query a database for the supplemental information.

17. The program of claim 12, further including:
logic configured to convert the work of content from a first format to a second format, wherein the work of content is received in the first format.

18. The program of claim 17, wherein the first format is an analog format, and the second format is a digital format.

19. The program of claim 18, wherein the analog format includes a vertical blanking interval carrying supplemental information, and further including:
logic configured to parse the supplemental information during the vertical blanking interval.

20. The program of claim 18, wherein the analog format includes a vertical blanking interval carrying information for an electronic program guide, and further including:
logic configured to parse the information for the electronic program guide during the vertical blanking interval; and
parse the supplemental information from the electronic program guide.

21. The program of claim 12, wherein the enhanced work of content is stored in an MPEG format, and the supplemental information record is stored in a transport packet having a reserved packet identifier.

22. The program of claim 12, wherein the enhanced work of content includes a program map table, the program map table associating a packet identifier with the supplemental information record.

23. An apparatus for processing a work of content, the apparatus comprising:
a memory having a supplemental information module stored therein;
a processor in communication with the memory, the processor adapted to receive a given work of multimedia content and implement the supplemental information module to generate a supplemental information record, which includes supplemental information related to the given work of content, and generate an enhanced work of content by embedding the supplemental information record into a bit stream comprising the given work of content.

24. The apparatus of claim 23, wherein the process is adapted to format the supplemental information record in accordance with a particular protocol, wherein the enhanced work of content is formatted in accordance with the particular protocol.

25. The apparatus of claim 23, further including:
a parser adapted to parse the work of content from a stream of transport packets; and parse selected transport packets carrying at least a portion of the supplemental information.

26. The apparatus of claim 23, further including:
a parser adapted to parse the supplemental information from the data for an electronic program guide.

27. The apparatus of claim 23, wherein the processor is adapted to query a database for at least a portion of the supplemental information.

28. The apparatus of claim 23, further including:
a encoder that receives the work of content in a first format and converts the work of content into a second format.

29. The apparatus of claim 28, wherein the first format is an analog format, and the second format is a digital format.

30. The apparatus of claim 29, wherein the analog format includes a vertical blanking interval carrying at least a portion of the supplemental information, and further including:
a parser that parses at least a portion the supplemental information during the vertical blanking interval.

31. The apparatus of claim 29, wherein the analog format includes a vertical blanking interval carrying information for an electronic program guide, and further including:
a parser that parses the information for the electronic program guide during the vertical blanking interval and parses at least a portion of the supplemental information from the electronic program guide.

32. The apparatus of claim 23, wherein the enhanced work of content is stored in an MPEG format, and the supplemental information record is stored in a transport packet having a reserved packet identifier.

33. The apparatus of claim 23, wherein the wherein the enhanced work of content includes a program map table, the program map table associating a packet identifier with the supplemental information record.

34. A method of recording an enhanced work of content, the method comprising the steps of:
receiving a program;
receiving program information, the program information including information that is related to the program;
embedding at least a portion of the program information into a bit stream that includes elementary streams of the program; and
recording the bit stream having the elementary streams of the program and at least a portion of the program information embedded therein.

35. The method of claim 34, further including the step of:
responsive to the program being received in an analog format, encoding the program into the bit stream.

36. The method of claim 34, further including the step of:
parsing the portion of the program information embedded in the bit stream from data for an electronic program guide.

37. An apparatus for recording a program, the apparatus comprising:
a memory having a supplemental information module stored therein;
a processor in communication with the memory, the processor adapted to receive a program of multimedia content and implement the supplemental information m module to generate a record containing supplemental information related to the program, and the processor further adapted to embed the record into a bit stream comprising the program.

38. The apparatus of claim 37, further including:
an encoder module, wherein responsive to the program being received in an analog format, the processor implements the encoder module and encodes the program into the bit stream.

39. The apparatus of claim 37, further including:
an electronic program guide module having data;
a parser module, wherein the processor implements the parser module to parse program information that is related to the program from the data of the electronic program guide, wherein at least a portion of the program information parsed from the data of the electronic program guide is included in the record embedded in the bit stream.
